(19) United States
(12) Patent Application Publication
(10) Pub. No.: US 2023/0184703 A1
(43) Pub. Date: Jun. 15, 2023

(54) QUANTITATIVE STATISTICAL CHARACTERIZATION METHOD OF MICRON-LEVEL SECOND PHASE IN ALUMINUM ALLOY BASED ON DEEP LEARNING

(71) Applicant: Central Iron & Steel Research Institute, Beijing (CN)

(72) Inventors: Dandan Sun, Beijing (CN); Bing Han, Beijing (CN); Weihao Wan, Beijing (CN); Haizhou Wang, Beijing (CN); Lei Zhao, Beijing (CN); Dongling Li, Beijing (CN); Caichang Dong, Beijing (CN)

(73) Assignee: Central Iron & Steel Research Institute, Beijing (CN)

(21) Appl. No.: 17/229,531

(22) Filed: Apr. 13, 2021

(30) Foreign Application Priority Data
Dec. 17, 2020 (CN) 202011500498X

(51) Int. Cl. G01N 23/2251; G06V 10/771; G01N 23/2202; G01N 1/32; G06V 10/26; G06V 10/774; G06T 7/136; G06T 7/62

(52) U.S. Cl. CPC G01N 23/2251; G06V 10/771; G01N 23/2202; G01N 1/32; G06V 10/26; G06V 10/774; G06T 7/136; G06T 7/62; G06T 2207/20032; G06T 2207/20036; G06T 2207/10061

(57) ABSTRACT

A quantitative statistical characterization method of micron-level second phase in aluminum alloy based on deep learning is disclosed. The method includes obtaining a feature database of the standard sample, training the feature database by the image segmentation network U-Net based on deep learning to obtain a U-Net segmentation model, selecting the corresponding parameters of the optimal precision and establishing a U-Net target model; clipping the aluminum alloy image to be detected and inputting the clipped images into the U-net target model, obtaining the size, area and position information of the second phase through the connected region algorithm, carrying out statistical distribution of the data set combined with the mathematical statistical method, and restoring the position information to the surface of the aluminum alloy to be tested to obtain the full-field quantitative statistical distribution and visualization results.

### TECHNICAL FIELD

The present disclosure relates to the technical field of characterization of micron-level second phase in aluminum alloy, and more specifically, to a quantitative statistical characterization method of micron-level second phase in aluminum alloy based on deep learning.

### BACKGROUND

The unmelted or refractory second phase particles in aluminum alloy are usually produced during casting, which cannot be remelted during subsequent heat treatment and hot deformation. These refractory second phases will be broken and elongated during deformation. They are arranged in a straight line along the deformation direction and consist of short complementary and connected strips. These particles are hard and brittle, distributed in the grain or grain boundary, and easy to form pores and microcracks on the phase interface during plastic deformation, which can significantly reduce the fracture toughness of the material. In addition, due to the difference of micro area electrochemistry between the second phase and the substrate, localized corrosion such as pitting corrosion, intergranular corrosion and stress corrosion are prone to occur. This not only reduces the reliability of high strength aluminum alloy and its components, but also significantly shortens the service life of the material.

At present, there is no unified standard for the quantitative characterization of micron-level second phase in aluminum alloys. Most of the existing methods use manual software tags, and the amount of data is usually dozens to hundreds of images. From a statistical point of view, the material is non-uniform, and the local field of view of tens to hundreds of sheets can not represent the real situation of tissue distribution. In addition, the software sheet processing can achieve high accuracy, but it needs a long time of manual participation, so it is not suitable for processing large quantities of data. Software batch processing can process a large number of images quickly, but due to the problem of generalization ability, it can not achieve high precision at the same time. Finally, at present, the quantitative characterization parameters of the second phase in aluminum alloys are relatively single, which are only common parameters such as area fraction and number, and lack of precise quantitative characterization of spatial and location distribution information.

With the development of science and technology, deep learning has strong adaptive, self-learning and parallel processing ability, which is more and more used in the field of image segmentation. High throughput scanning electron microscope has the characteristics of high efficiency and high speed. It can obtain large-scale full field scanning images in a short time, which provides an effective way to obtain data sets and solves the problem of data set source. The combination of high throughput image data acquisition method and artificial intelligence method is the application trend of material characterization. Therefore, it is significant to strengthen the application of high throughput scanning electron microscope and deep learning algorithm in the quantitative characterization of micron-level second phase in aluminum alloy, and it is also an important research topic.

### SUMMARY

The disclosure provides a quantitative statistical characterization method of micron-level second phase in aluminum alloy based on deep learning. High throughput image data acquisition method and deep learning algorithm are used to realize the automatic identification of micron-level second phase in aluminum alloy. Combined with mathematical methods, a variety of characterization parameters of second phase are mined, and the distribution differences between the whole field of view and zones on the surface of materials are quantitatively counted. The problem of traditional single quantitative characterization parameters of second phase in aluminum alloy is solved. The provided method has the characteristics of large field of view, complete information, accuracy and reliability.

Technical solutions of the present disclosure are specifically described as follows.

A quantitative statistical characterization method of micron-level second phase in aluminum alloy based on deep learning is provided, including:

a) selecting a standard aluminum alloy sample and polishing a sample surface to obtain a micron-level second phase image of the sample surface;

b) carrying out an image segmentation based on the micron-level second phase image, screening out a feature data set, and generating a feature database;

c) training the feature database by using an image segmentation network U-Net based on deep learning, and obtaining a U-NET segmentation model;

d) inputting the original image in the untrained feature database into the obtained U-Net segmentation model; taking a binary image screened manually in the feature database as a standard, comparing and verifying an accuracy value of binary images predicted by the U-Net segmentation model; taking an intersection-union ratio IOU as an evaluation index, and evaluating an segmentation accuracy of the segmentation model; selecting parameters corresponding to an optimal accuracy and establishing an U-Net target model;

e) continuously and automatically acquiring microstructures of the polished aluminum alloy surface to be tested by using a high throughput scanning electron microscope, and obtaining aluminum alloy images to be detected;

f) clipping the single aluminum alloy image acquired in step e), inputting the clipped serial test images into the U-Net target model established in step d), segmenting and extracting second phase in the aluminum alloy to be tested, and obtaining binary images;

g) processing the binary images obtained in step f) by a connected region algorithm to obtain a complete data set, wherein the data set comprises size, area and position information of each second phase;

h) carrying out a statistical distribution characterization on the data set according to mathematical statistical method, and restoring the position information in the image to be detected to the aluminum alloy surface to be tested, and obtaining a full-field quantitative statistical distribution and visualization result.

Further, in step a), the step of selecting a standard aluminum alloy sample and polishing a sample surface to obtain micron-level second phase images of the sample surface specifically includes:

grinding and polishing the standard aluminum alloy sample surface, wherein mechanical polishing is adopted, and SiO₂ grinding paste is used as a polishing agent;

using a high throughput automatic scanning electron microscope of Navigator-OPA, acquiring a microstructural image of the polished standard aluminum alloy sample surface and obtaining the micron-level second phase image.

Further, in step b), the step of carrying out an image segmentation based on the micron-level second phase images, screening out a feature data set, and generating a feature database specifically comprises:

segmenting a single image by MIPAR image processing software, and establishing an accurate segmentation template; wherein the segmenting process comprises four steps of median filtering, threshold segmentation, morphology processing and interference screening;

importing the segmentation template into a batch processing area, performing a batch segmentation on the micron-level second phase image in the data set, then performing single manual screening, and generating the feature database from the screened feature data set.

Further, in step c), the left side of the image segmentation network U-Net is a lower sampling layer alternately combined by a convolution layer and a pooling layer, and an activation function adopts ReLu to shrink the path of the input image to capture global content; the right side of the image segmentation network U-Net is a upper sampling layer alternately combined by a convolution layer and a deconvolution layer, and the path of the feature image of the lower sampling layer is expanded in training process to accurately locate each pixel of the image.

Further, in step e), the aluminum alloy to be tested is treated by the same polishing and image acquisition methods as the standard aluminum alloy sample.

Further, in step e), the microstructures of the polished aluminum alloy surface to be tested are continuously and automatically acquired by using a high throughput scanning electron microscope, and an overlap area of any two consecutive images is set to 0-10%.

Further, in step h), when the second phase is characterized by a mathematical statistical method, a nearest neighbor Euclidean distance parameter is introduced to represent a minimum distance of two adjacent insoluble phases in the space.

Further, in step h), when the second phase is characterized by a mathematical statistical method, a length-width ratio parameter is introduced, and the length is Ferret diameter, and the width is the ratio of the pixel area to the Ferret diameter.

Further, in step e), the microstructures of the polished aluminum alloy surface to be tested are continuously and automatically acquired by using a high throughput scanning electron microscope, and the acquired image is 4096*4096 pixels, and there is no overlapping area between adjacent images.

According to the specific embodiments provided in the present disclosure, following beneficial effects are disclosed.

Firstly, the current methods mainly rely on artificial visual observation or the combination of artificial and image processing software to complete the evaluation and quantitative statistics. The software can achieve high accuracy for single image processing, but the efficiency is very low. The software batch processing can achieve fast statistics, but due to the poor generalization ability, the segmentation accuracy is not enough. Based on high throughput scanning electron microscope, combined with deep learning image segmentation and extraction algorithm and mathematical statistics algorithm, the segmentation model can automatically and quickly realize the segmentation and extraction of micron-level second phase in aluminum alloy, and improve the image processing efficiency.

Secondly, the current second phase statistics is the image analysis of a single field of view, the number of observation field area and microstructure is limited. The disclosure obtains a large-scale continuous feature map with an area of more than 100 square mm through large-scale full field automatic acquisition. Because of the statistical analysis of the full field of view image, the statistical error of single field of view is greatly eliminated. Therefore, the disclosure has the advantages of large field of view and complete information, and the statistical data is more accurate and reliable.

Thirdly, the current deep learning method needs complex manual marks when making labels. In the method disclosed, a single image is processed by MIPAR software to obtain an accurate segmentation template. On the basis of the template, the image is processed in batches, and then the label is made by manual single screening. the method avoids complex manual marking and saves labor time.

Fourthly, the current characterization parameters of the second phase are relatively single. In the method disclosed, through the segmentation and extraction of large-scale image features, many fine characterization results can be achieved, such as the statistics of location and spatial information, the quantitative distribution statistics of global and local regions and so on.

### BRIEF DESCRIPTION OF THE DRAWINGS

In order to explain the embodiments of the present disclosure or the technical solutions in the prior art more clearly, the following drawings that need to be used in the description of the embodiments or the prior art will be briefly introduced. Obviously, the drawings in the following description are only embodiments of the present disclosure. For those of ordinary skill in the art, other drawings can be obtained based on the drawings disclosed without creative work.

FIG. 1 is a flow chart of the quantitative statistical characterization method of micron-level second phase in aluminum alloy based on deep learning;

FIG. 2 (a) is a micron-level second phase image of T4-6 aluminum alloy in the embodiment of the present disclosure;

FIG. 2 (b) is a micron-level second phase image of T4-15 aluminum alloy in the embodiment of the present disclosure;

FIG. 2 (c) is a micron-level second phase image of T5-10 aluminum alloy in the embodiment of the present disclosure;

FIG. 2 (d) is a micron-level second phase image of T5-15 aluminum alloy in the embodiment of the present disclosure;

FIG. 3 is an image segmentation network U-Net of the embodiment of the present disclosure;

FIG. 4 shows the image segmentation details of the embodiment of the present disclosure;

FIG. 5 (a) is a visualization image of the area distribution of T4-6 second phase in the range of 50 mm², with the area of 236 μm² as the statistical unit;

FIG. 5 (b) is a visualization image of the area distribution of T4-15 second phase in the range of 120 mm², with the area of 655 μm² as the statistical unit;

FIG. 5 (c) is a visualization image of the area distribution of T5-10 second phase in the range of 70 mm², with the area of 655 μm² as the statistical unit;

FIG. 5 (d) is a visualization image of the area distribution of T5-15 second phase in the range of 110 mm² with the area of 655 μm² as the statistical unit;

FIG. 6 (a) is a visualization image of the quantity distribution of T4-6 second phase in the range of 50 mm², with the area of 236 μm² as the statistical unit;

FIG. 6 (b) is a visualization image of the quantity distribution of T4-15 second phase in the range of 120 mm² with the area of 655 μm² area as the statistical unit;

FIG. 6 (c) is a visualization image of the quantity distribution of T5-10 second phase in the range of 70 mm², with the area of 655 μm² as the statistical unit;

FIG. 6 (d) is a visualization image of the quantity distribution of T5-15 second phase in the range of 110 mm² with the area of 655 μm² as the statistical unit;

FIG. 7 (a) to FIG. 7 (d) are frequency distribution diagrams of nearest neighbor second phases Euclidean distance of the four materials T4-6, T4-15, T5-10 and T5-15 in the embodiment of the present disclosure;

FIG. 8 (a) to FIG. 8 (d) are the frequency distribution diagrams of length-width ratio of the four materials T4-6, T4-15, T5-10 and T5-15 in the embodiment of the present disclosure.

### DETAILED DESCRIPTION OF EMBODIMENTS

Certain exemplary embodiments will now be described to provide an overall understanding of the principles of the structure, function, manufacture, and use of the instruments and methods disclosed herein. One or more examples of these embodiments are illustrated in the accompanying drawings. Those skilled in the art will understand that the instruments and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

The disclosure provides a quantitative statistical characterization method of micron-level second phase in aluminum alloy based on deep learning. High throughput image data acquisition method and deep learning algorithm are used to realize the automatic identification of micron-level second phase in aluminum alloy. Combined with mathematical methods, a variety of characterization parameters of second phase are mined, and the distribution differences between the whole field of view and zones on the surface of materials are quantitatively counted. The problem of traditional single quantitative characterization parameters of second phase in aluminum alloy is solved. The provided method has the characteristics of large field of view, complete information, accuracy and reliability. The method avoids the subjective error caused by manual selection of field of view, and solves the problem of low efficiency in manual measurement and statistics. The method avoids manual marking of data sets, and saves manual time. The method realizes automatic, accurate, comprehensive and rapid characterization of micron-level second phase in aluminum alloy.

In order to make the above objects, features and advantages of the disclosure more obvious and easier to understand, the disclosure will be further described in detail in combination with the drawings and the specific embodiments.

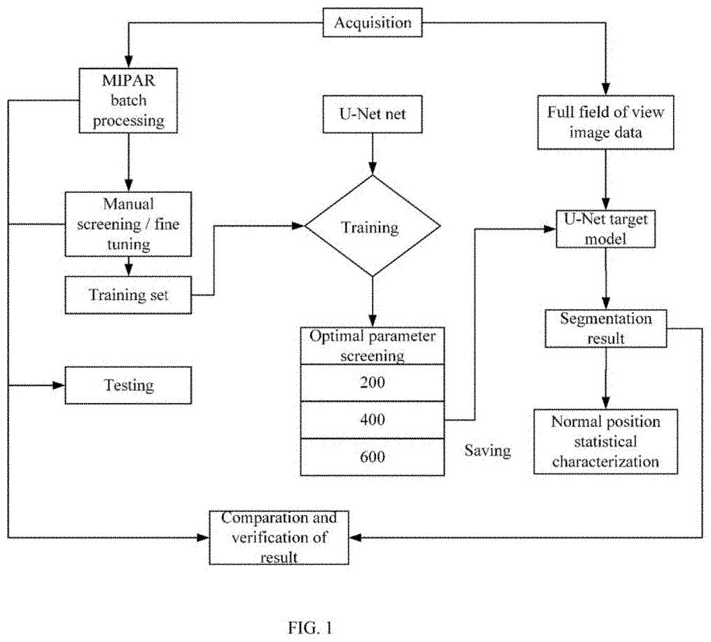

As shown in FIG. 1, a quantitative statistical characterization method of micron-level second phase in aluminum alloy based on deep learning is provided, including:

a) selecting a standard aluminum alloy sample and polishing a sample surface to obtain a micron-level second phase image of the sample surface;

b) carrying out an image segmentation based on the micron-level second phase image, screening out a feature data set, and generating a feature database;

c) training the feature database by using an image segmentation network U-Net based on deep learning, and obtaining a U-NET segmentation model;

d) inputting the original image in the untrained feature database into the obtained U-Net segmentation model; taking a binary image screened manually in the feature database as a standard, comparing and verifying an accuracy value of binary images predicted by the U-Net segmentation model; taking an intersection-union ratio IOU as an evaluation index, and evaluating an segmentation accuracy of the segmentation model; selecting parameters corresponding to an optimal accuracy and establishing an U-Net target model;

e) continuously and automatically acquiring microstructures of the polished aluminum alloy surface to be tested by using a high throughput scanning electron microscope, and obtaining aluminum alloy images to be detected;

f) clipping the single aluminum alloy image acquired in step e), inputting the clipped serial test images into the U-Net target model established in step d), segmenting and extracting second phase in the aluminum alloy to be tested, and obtaining binary images;

g) processing the binary images obtained in step f) by a connected region algorithm to obtain a complete data set, wherein the data set comprises size, area and position information of each second phase;

h) carrying out a statistical distribution characterization on the data set according to mathematical statistical method, and restoring the position information in the image to be detected to the aluminum alloy surface to be tested, and obtaining a full-field quantitative statistical distribution and visualization result.

In step a), the step of selecting a standard aluminum alloy sample and polishing a sample surface to obtain micron-level second phase images of the sample surface specifically includes:
grinding and polishing the standard aluminum alloy sample surface, wherein mechanical polishing is adopted, and SiO₂ grinding paste is used as a polishing agent;
using a high throughput automatic scanning electron microscope of Navigator-OPA, acquiring a microstructural image of the polished standard aluminum alloy sample surface and obtaining the micron-level second phase image.

In step b), the step of carrying out an image segmentation based on the micron-level second phase images, screening out a feature data set, and generating a feature database specifically comprises:
segmenting a single image by MIPAR image processing software, and establishing an accurate segmentation template; wherein the segmenting process comprises four steps of median filtering, threshold segmentation, morphology processing and interference screening;
importing the segmentation template into a batch processing area, performing a batch segmentation on the micron-level second phase image in the data set, then performing single manual screening, and generating the feature database from the screened feature data set.

Where, it takes about 60 s for PIPAR image processing software to segment a single image, and 0.4016 s for batch processing each image.

In step c), the left side of the image segmentation network U-Net is a lower sampling layer alternately combined by a convolution layer and a pooling layer, and an activation function adopts ReLu to shrink the path of the input image to capture global content; the right side of the image segmentation network U-Net is a upper sampling layer alternately combined by a convolution layer and a deconvolution layer, and the path of the feature image of the lower sampling layer is expanded in training process to accurately locate each pixel of the image.

In step d), the U-Net network predicts that the highest IOU of the second phase is 86.22%.

In step e), the aluminum alloy to be tested is treated by the same polishing and image acquisition methods as the standard aluminum alloy sample; the microstructures of the polished aluminum alloy surface to be tested are continuously and automatically acquired by using a high throughput scanning electron microscope, and an overlap area of any two consecutive images is set to 0-10%, and the acquired image is 4096*4096 pixels, and there is no overlapping area between adjacent images.

In the step f), the aluminum alloy test image is formed by clipping a single image into four 2048*2048 pixel sequence backscatter images according to the position; the segmentation time of the single test image is 0.4031 s.

In the step g), the acquisition area is more than 100 mm², and the number of second phases is close to 400000.

In step h), when the second phase is characterized by a mathematical statistical method, a nearest neighbor Euclidean distance parameter and a length-width ratio parameter are introduced, where the nearest neighbor Euclidean distance parameter represents a minimum distance of two adjacent insoluble phases in the space, and the length is Ferret diameter, and the width is the ratio of the pixel area to the Ferret diameter.

In the specific embodiment, four different specifications of aluminum alloy for corbels are selected, and the composition is shown in Table 1. At present, the corbel materials of high-speed railway in China still rely on imports. Compared with imported materials, the weathering steel produced in China has low overall stability and poor durability. The fundamental reason is that the control accuracy of composition and microstructure of the materials produced in China is low and fluctuates greatly. Therefore, it is of great significance to evaluate the microstructure uniformity of aluminum alloy for corbels by high throughput characterization for the study of the stability and durability of materials for corbels.

TABLE 1
Chemical composition of four aluminum alloys

| Element | Zn | Mg | Cu | Fe | Si | Mn | Cr | Zr | Ti |
|---|---|---|---|---|---|---|---|---|---|
| T4-6 | 4.53 | 1.1 | 0.23 | 0.17 | 0.088 | 0.34 | 0.18 | 0.12 | 0.046 |
| T4-15 | 4.39 | 1.38 | 0.022 | 0.16 | 0.067 | 0.35 | 0.084 | 0.071 | 0.02 |
| T5-10 | 4.31 | 1.01 | 0.15 | 0.17 | 0.062 | 0.37 | 0.23 | 0.097 | 0.05 |
| T5-15 | 4.23 | 1.09 | 0.16 | 0.17 | 0.058 | 0.37 | 0.22 | 0.11 | 0.048 |

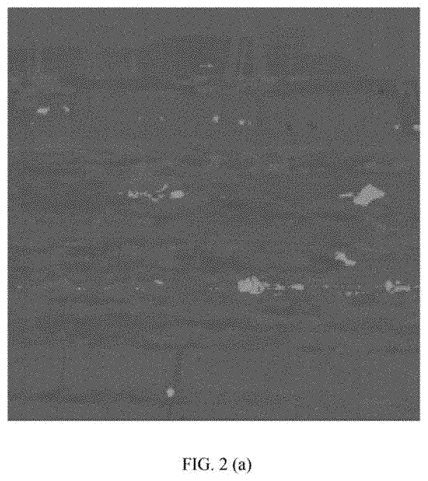

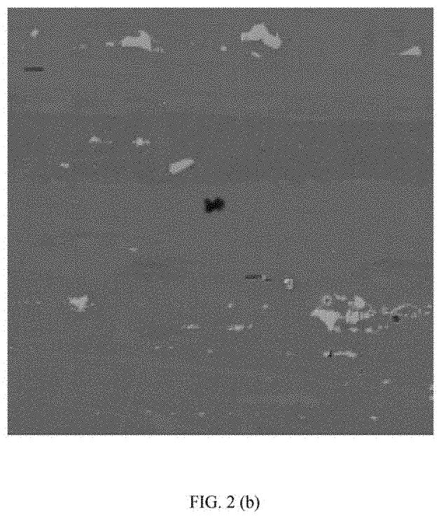

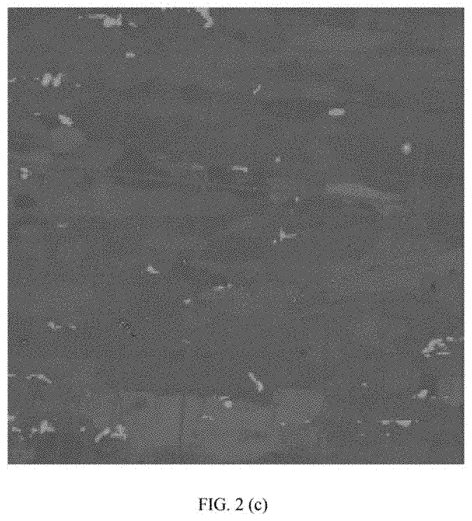

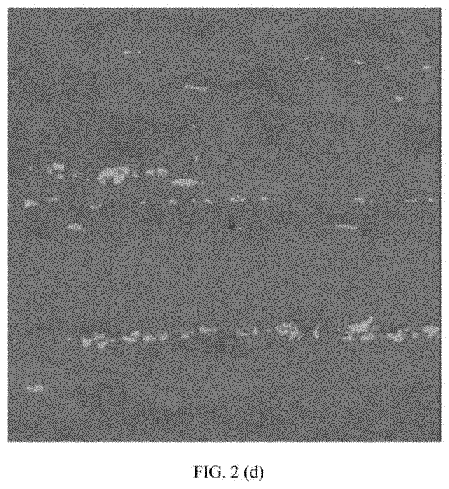

Firstly, the micron-level second phase images of the four aluminum alloy materials obtained in step a) were shown in FIG. 2 (a)-(d), and the pixel size was 4096*4096. The standard image obtained in step a) was segmented by MIPAR image processing software, and the segmentation template was established, and the process of the segmentation template was median filtering, threshold segmentation, morphological processing and interference screening. The time of single image segmentation was about 60 s. In step b), 3200 batch images of 2048*2048 pixels were imported in the MIPAR image processing software and subjected to segmentation processing by the segmentation template. A single image took 0.4016 s. The segmented single image was manually screened, and the segmentation effect was optimized by fine tuning the parameters, and the feature database was established.

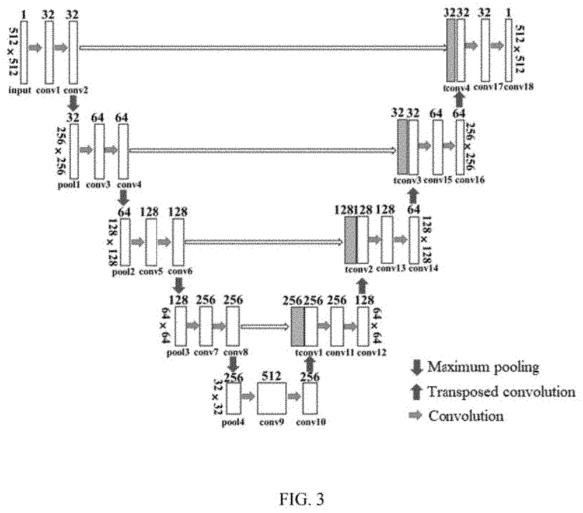

U-Net image segmentation network was established, and the network framework is shown in FIGS. 3. 800, 1600 and 2400 images with 2048*2048 pixels were used as training data respectively. After training, the parameters were saved and the target segmentation model is established. The original image in the untrained feature database was input into the established segmentation model, and the accuracy of the binary image predicted by U-Net network was compared and verified with the manually screened binary image in the feature database as the standard. The comparison of test accuracy of three different training sets is shown in Table 2.

TABLE 2

| Image | | | | MIPAR | |
|---|---|---|---|---|---|
| processing | | | | batch | Manual |
| method | U-Net | | | processing | screening |
| IOU | 200 | 400 | 60 | 0.4274 | 100% |
| | 0.8257 | 0.8106 | 0.8622 | | |

| | | | |
|---|---|---|---|
| Time | 0.4031s | 0.4016 s | 60 s |

The cross-section dimensions of the four kinds of aluminum alloy plates to be tested in the vertical rolling direction are 50 mm², 120 mm², 70 mm² and 110 mm² respectively. In the same way as step a), high throughput scanning electron microscope of Navigator-OPA was used to automatically acquired the full field microstructural characteristics of the polished samples. 3362, 11508, 7056 and 10668 original backscatter images with 4096*4096 pixels were obtained.

The images to be detected obtained in step e) were cropped into a small field of view image of 2048*2048 pixels. The clipped images to be tested were input into the U-Net image segmentation model based on deep learning established in step c) for testing.

The connected region algorithm was used to make statistics on the binary image obtained in step e) to obtain a complete data set, including the position, area, size and other information of the second phase in a large scale and full field of view. The statistical results are shown in Table 3. The surface area of the sample was divided into the upper surface area, the middle area and the lower surface area, which were represented by 1/3, 2/3 and 3/3 respectively. The statistical results between the zones are shown in Table 4, showing the quantity, area proportion and average area of the second phase respectively.

TABLE 3

| | T4-6 | T4-15 | T5-10 | T5-15 |
|---|---|---|---|---|
| Feature area | 0.22 | 0.47 | 0.29 | 0.60 |
| (mm²) | | | | |
| Acquired | 50.76 | 120.67 | 73.98 | 111.86 |
| area(mm²) | | | | |
| Area | 0.42 | 0.39 | 0.38 | 0.54 |
| proportion % | | | | |
| Number of | 111249 | 305123 | 255955 | 390119 |
| second phase | | | | |
| Number of | 2191 | 2528 | 3459 | 3487 |
| unit area | | | | |
| Average area | 1.94 | 1.55 | 1.12 | 1.54 |
| of second | | | | |
| phase | | | | |

TABLE 4

| | T4-6 | | | T4-15 | | |
|---|---|---|---|---|---|---|
| Position | Number | Area | Mean | Number | Area | Mean |
| 1/3 | 0.301791 | 0.301649225 | 1.987738 | 0.336107078 | 0.33154 | 1.526703773 |
| 2/3 | 0.308812 | 0.338431274 | 2.179418 | 0.287467677 | 0.31638 | 1.703433307 |
| 3/3 | 0.389397 | 0.3599195 | 1.838133 | 0.376425245 | 0.35208 | 1.447660848 |

| | T5-10 | | | T5-15 | | |
|---|---|---|---|---|---|---|
| Position | Number | Area | Mean | Number | Area | Mean |
| 1/3 | 0.30146 | 0.341072739 | 1.26882324 | 0.3544 | 0.325 | 1.419045 |
| 2/3 | 0.32256 | 0.365541503 | 1.27089928 | 0.3187 | 0.3343 | 1.623715 |
| 3/3 | 0.37599 | 0.293385758 | 0.87506874 | 0.3269 | 0.3407 | 1.612832 |

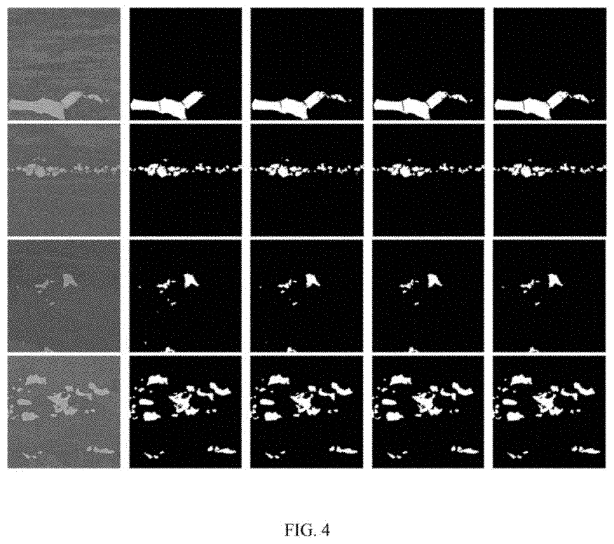

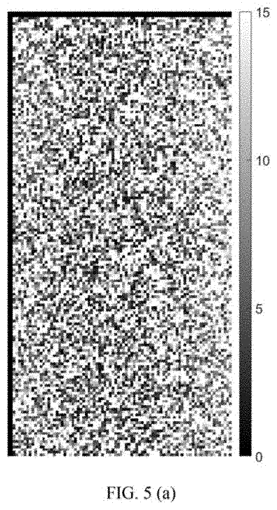

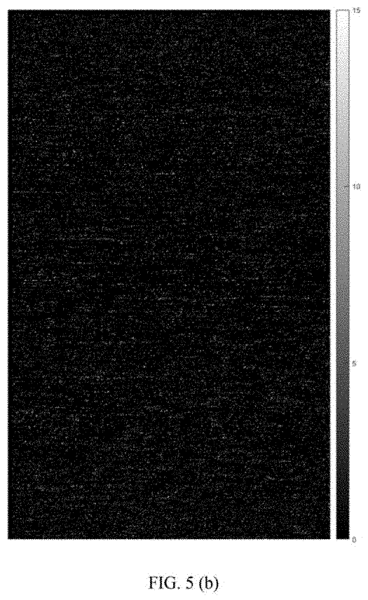

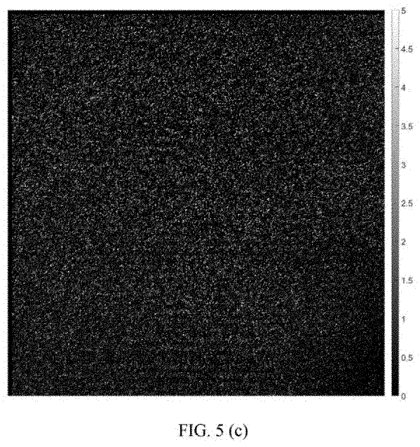

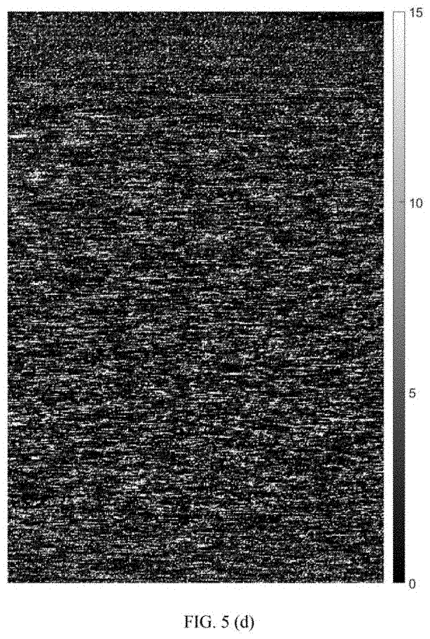

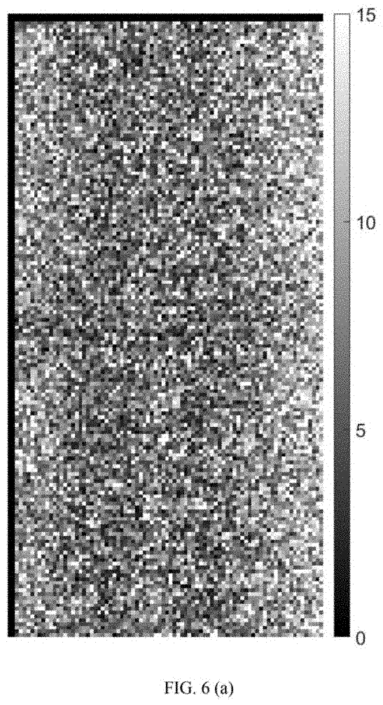

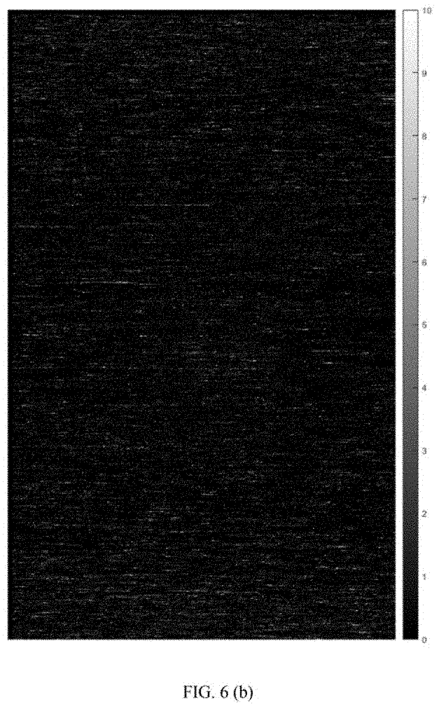

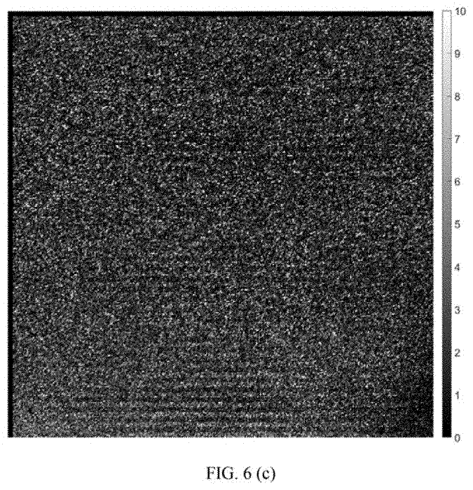

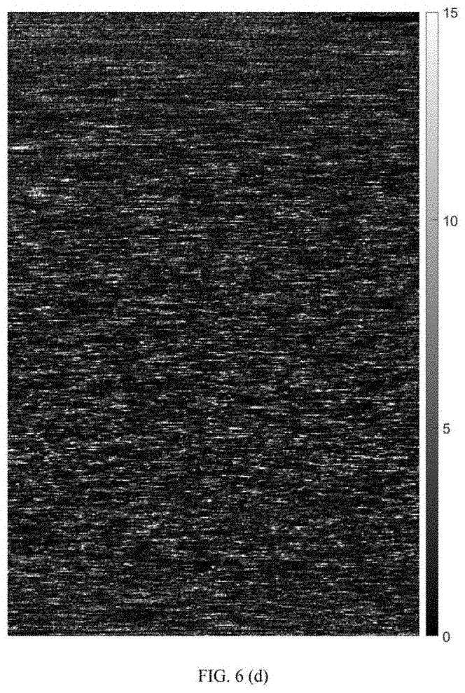

As shown in FIGS. 5 (a)-(d), it is the area distribution visualization image of the second phase in the range of 50 mm², 120 mm², 70 mm² and 110 mm² obtained by taking the area of 236 μm² and 655 μM² as statistical units for four kinds of aluminum alloy materials. FIGS. 6 (a)-(d) show the quantity distribution visualization images of the second phase in four kinds of aluminum alloy materials. It can be seen that the area distribution of the middle area was larger and the number was less, while the surface area was larger and the area distribution was smaller; the distribution direction was consistent with the rolling direction, and the larger the thickness was, the more obvious the trend was; in addition, the enrichment and loss phenomenon appeared in some areas.

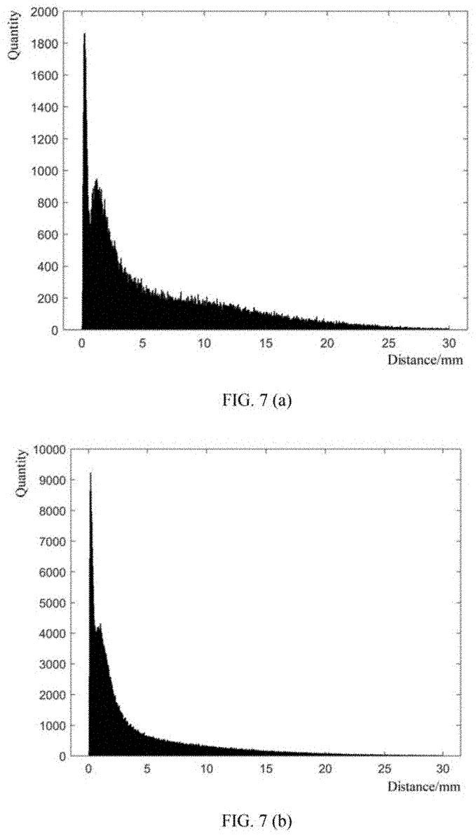

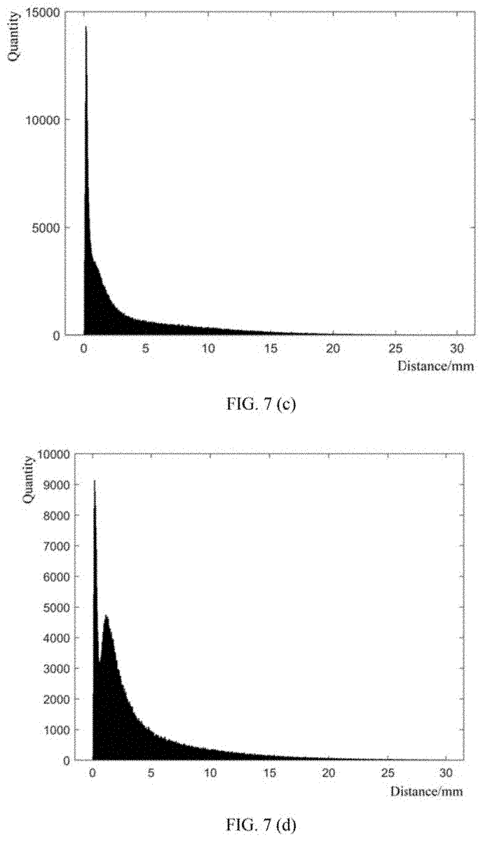

In addition, the second phase spacing is closely related to crack resistance, fracture toughness and pitting corrosion. The location information of each image was restored to the cross section of the sample by mathematical statistical method, and the minimum Euclidean distance of adjacent features was calculated by partition to characterize the spatial distribution of the second phase. FIGS. 7 (a)-(d) show the frequency distribution of the minimum spacing of the four materials respectively. It can be seen from that the frequency distribution of the four materials was consistent, and there were two peaks, respectively in the 0-1 and 1-2 micron ranges, indicating that most insoluble phases were aggregated.

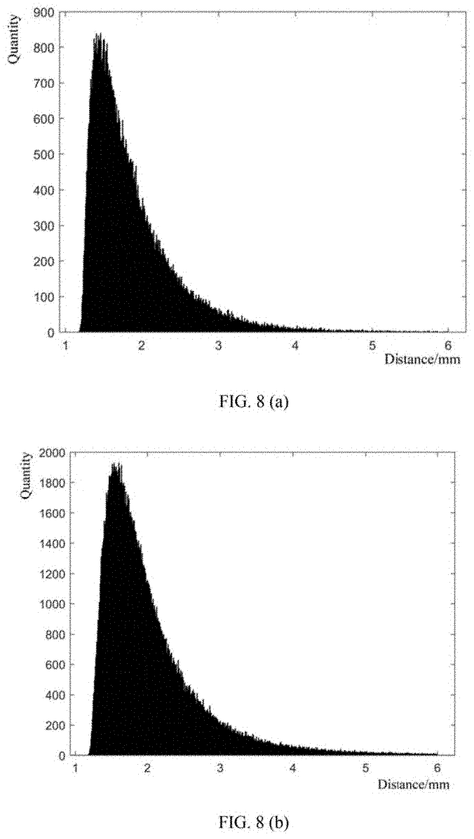

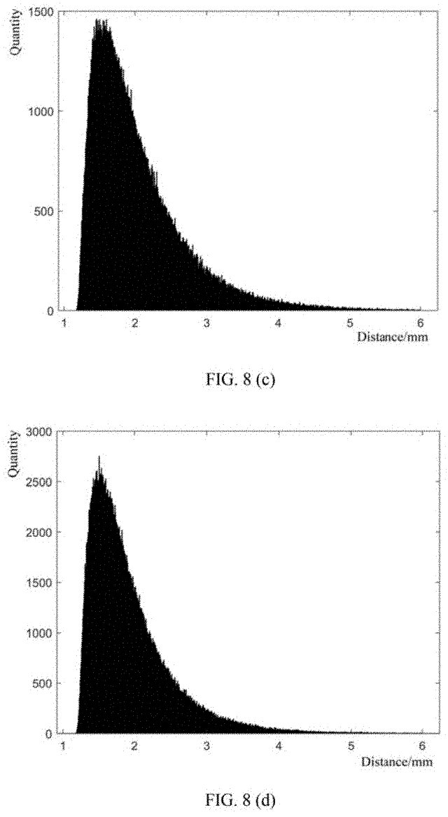

The shape of the micron-level second phase is characterized by the length-width ratio parameter, where the length is the Ferret diameter and the width is the ratio of the pixel area to the Ferret diameter. FIGS. 8 (a)-(d) show the frequency histogram of length-width ratio distribution of the four materials. It can be seen that the frequency histogram of the length-width ratio distribution of the four materials was consistent, and the peak distribution was in the range of 1.5-2.

In the step e) of the disclosure, the polished aluminum alloy surface was acquired by the high throughput scanning electron microscope, and the sequential images were continuously acquired in a short time. The overall acquisition speed was 10 times faster than that of the ordinary electron microscope, and the large-scale image information was obtained to realize the high throughput acquisition of image data. MIPAR batch processing and manual fine-tuning were combined in the process of deep learning dataset production, which greatly saves labor time. The images to be tested were input into the trained image segmentation model, and the output time was 0.4031 s and the accuracy was 86.22%. In step g), the complete global data including the size, number, area and position of the second phase in the cross section was obtained. In step h), the region with appropriate size was selected as the statistical unit to obtain the statistical distribution information of large-scale cross section and between regions, and the global data was visualized; in addition, the nearest neighbor Euclidean distance and length-width ratio were realized to characterize the spatial distribution and shape information of the second phase on the sample surface. In conclusion, the method was used for automatic identification, segmentation and quantitative statistical characterization of micron-level second phase in aluminum alloy in large scale.

The quantitative statistical characterization method of micron-level second phase in aluminum alloy based on deep learning provided in the disclosure is based on deep learning, and the second phase images are quickly acquired based on high throughput scanning electron microscope to obtain continuously distributed image data. Based on deep learning semantic segmentation algorithm, the second phase target in continuous images is subjected to automatic recognition and segmentation. Finally, the area, size, number, distribution density, shape factor and other information of the extracted second phase are mined by mathematical method, and the distribution difference between the whole field of view and the partition of the material surface is calculated quantitatively. The disclosure is able to automatically and quickly realize the full field of view positioning and extraction of the second phase, finely characterize the size, area, position, length-width ratio and distribution information of the second phase, and solve the problems of small field of view, low efficiency, low precision and single statistical information caused by manual identification, measurement and statistics of microstructure.

The above description of the disclosed embodiments enables those skilled in the art to achieve or use the disclosure. Multiple modifications to these embodiments will be apparent to those skilled in the art, and the general principles defined herein may be achieved in other embodiments without departing from the spirit or scope of the disclosure. The present disclosure will therefore not be restricted to these embodiments shown herein, but rather to comply with the broadest scope consistent with the principles and novel features disclosed herein.

1. A quantitative statistical characterization method of micron-level second phase in aluminum alloy based on deep learning, comprising:
a) selecting a standard aluminum alloy sample and polishing a sample surface to obtain a micron-level second phase image of the sample surface;
b) carrying out an image segmentation based on the micron-level second phase image, screening out a feature data set, and generating a feature database;
c) training the feature database by using an image segmentation network U-Net based on deep learning, and obtaining a U-NET segmentation model;
d) inputting the original image in the untrained feature database into the obtained U-Net segmentation model; taking a binary image screened manually in the feature database as a standard, comparing and verifying an accuracy value of binary images predicted by the U-Net segmentation model; taking an intersection-union ratio IOU as an evaluation index, and evaluating an segmentation accuracy of the segmentation model; selecting parameters corresponding to an optimal accuracy and establishing an U-Net target model;
e) continuously and automatically acquiring microstructures of the polished aluminum alloy surface to be tested by using a high throughput scanning electron microscope, and obtaining aluminum alloy images to be detected;
f) clipping the single aluminum alloy image acquired in step e), inputting the clipped serial test images into the U-Net target model established in step d), segmenting and extracting second phase in the aluminum alloy to be tested, and obtaining binary images;
g) processing the binary images obtained in step f) by a connected region algorithm to obtain a complete data set, wherein the data set comprises size, area and position information of each second phase;
h) carrying out a statistical distribution characterization on the data set according to mathematical statistical method, and restoring the position information in the image to be detected to the aluminum alloy surface to be tested, and obtaining a full-field quantitative statistical distribution and visualization result.

2. The quantitative statistical characterization method of micron-level second phase in aluminum alloy based on deep learning of claim 1, wherein in step a), the step of selecting a standard aluminum alloy sample and polishing a sample surface to obtain micron-level second phase images of the sample surface specifically comprises:
grinding and polishing the standard aluminum alloy sample surface, wherein mechanical polishing is adopted, and SiO₂ grinding paste is used as a polishing agent;
using a high throughput automatic scanning electron microscope of Navigator-OPA, acquiring a microstructural image of the polished standard aluminum alloy sample surface and obtaining the micron-level second phase image.

3. The quantitative statistical characterization method of micron-level second phase in aluminum alloy based on deep learning of claim 1, wherein in step b), the step of carrying out an image segmentation based on the micron-level second phase images, screening out a feature data set, and generating a feature database specifically comprises:
segmenting a single image by MIPAR image processing software, and establishing an accurate segmentation template; wherein the segmenting process comprises four steps of median filtering, threshold segmentation, morphology processing and interference screening;
importing the segmentation template into a batch processing area, performing a batch segmentation on the micron-level second phase image in the data set, then performing single manual screening, and generating the feature database from the screened feature data set.

4. The quantitative statistical characterization method of micron-level second phase in aluminum alloy based on deep learning of claim 1, wherein in step c), the left side of the image segmentation network U-Net is a lower sampling layer alternately combined by a convolution layer and a pooling layer, and an activation function adopts ReLu to shrink the path of the input image to capture global content; the right side of the image segmentation network U-Net is a upper sampling layer alternately combined by a convolution layer and a deconvolution layer, and the path of the feature image of the lower sampling layer is expanded in training process to accurately locate each pixel of the image.

5. The quantitative statistical characterization method of micron-level second phase in aluminum alloy based on deep learning of claim 2, wherein in step e), the aluminum alloy to be tested is treated by the same polishing and image acquisition methods as the standard aluminum alloy sample.

6. The quantitative statistical characterization method of micron-level second phase in aluminum alloy based on deep learning of claim 1, wherein in step e), the microstructures of the polished aluminum alloy surface to be tested are continuously and automatically acquired by using a high throughput scanning electron microscope, and an overlap area of any two consecutive images is set to 0-10%.

7. The quantitative statistical characterization method of micron-level second phase in aluminum alloy based on deep learning of claim 1, wherein in step h), when the second phase is characterized by a mathematical statistical method, a nearest neighbor Euclidean distance parameter is introduced to represent a minimum distance of two adjacent insoluble phases in the space.

8. The quantitative statistical characterization method of micron-level second phase in aluminum alloy based on deep learning of claim 1, wherein in step h), when the second phase is characterized by a mathematical statistical method, a length-width ratio parameter is introduced, and the length is Ferret diameter, and the width is the ratio of the pixel area to the Ferret diameter.

9. The quantitative statistical characterization method of micron-level second phase in aluminum alloy based on deep learning of claim 1, wherein in step e), the microstructures of the polished aluminum alloy surface to be tested are continuously and automatically acquired by using a high throughput scanning electron microscope, and the acquired image is 4096*4096 pixels, and there is no overlapping area between adjacent images.
